(19) United States
(12) Patent Application Publication
(10) Pub. No.: US 2016/0137123 A1
(43) Pub. Date: May 19, 2016

(54) Alarm and signalling device of a user moving away from a child on board a vehicle

(71) Applicant: Ermanno FAINI, BRESCIA (IT)

(72) Inventor: Ermanno Faini, Brescia (IT)

(21) Appl. No.: 14/901,083

(22) PCT Filed: Jun. 13, 2014
(86) PCT No.: PCT/IB2014/062208

§ 371 Date: Dec. 28, 2015

(30) Foreign Application Priority Data
Jun. 27, 2013 (IT) BS2013A000092

(51) Int. Cl. B60Q 9/00; B60R 22/10; G08B 21/24

(52) U.S. Cl. CPC B60Q 9/00; G08B 21/24; B60R 22/105

(57) ABSTRACT

A safety device (1), in particular an alarm and signalling device of moving away from a child on board a vehicle, comprises:
a strap (10) suitable to be worn by the user on board the vehicle,
a base (40) suitable to be attached to the vehicle,
an alarm (20), attached to the strap (10) or to the base (40), suitable for emitting an acoustic signal when the strap (10) detaches from the base (40), so as to signal to the user, at the moment of getting out of the vehicle that he is moving away from a child on board the vehicle.

The present invention relates to a safety device, in particular an alarm and signalling device of a user moving away from a child on board a vehicle.

Given recent news events, increasing attention is paid to the problem of child deaths caused by forgetfulness of their parents or relatives, who forget to take the child out of the vehicle at the time of arrival at destination.

In particular, increasing interest has been aroused by alarm devices which activate to indicate the presence of a child on board, usually seated in the car seat placed on the back seat.

Some examples of alarm devices suitable to indicate the presence of a child in the vehicle are known from the patent documents U.S. Pat. No. 7,123,157 and U.S. Pat. No. 6,104,293. Such devices comprise alarm systems connected to devices for detecting the presence of the child on the seat, such as weight detectors. Such devices are therefore relatively complex and expensive, in that they require substantial intervention on the seat or on the vehicle itself.

The need is also particularly felt for such safety devices to be extremely reliable and able to signal the presence of a child on board even in case of malfunction of the alarm device.

The purpose of the present invention is to resolve the problems of the prior art taking into account the needs of the sector.

In particular, the object of the present invention is to provide a safety device, in particular an alarm and signalling device of moving away from a child in the vehicle, which is simple and reliable at the same time.

Such purpose is achieved by a safety device made according to claim 1. The dependent claims describe preferred or advantageous embodiments of the safety device.

The characteristics and advantages of the safety device according to the present invention will be evident from the description given below, by way of a non-limiting example, according to the appended drawings, wherein:

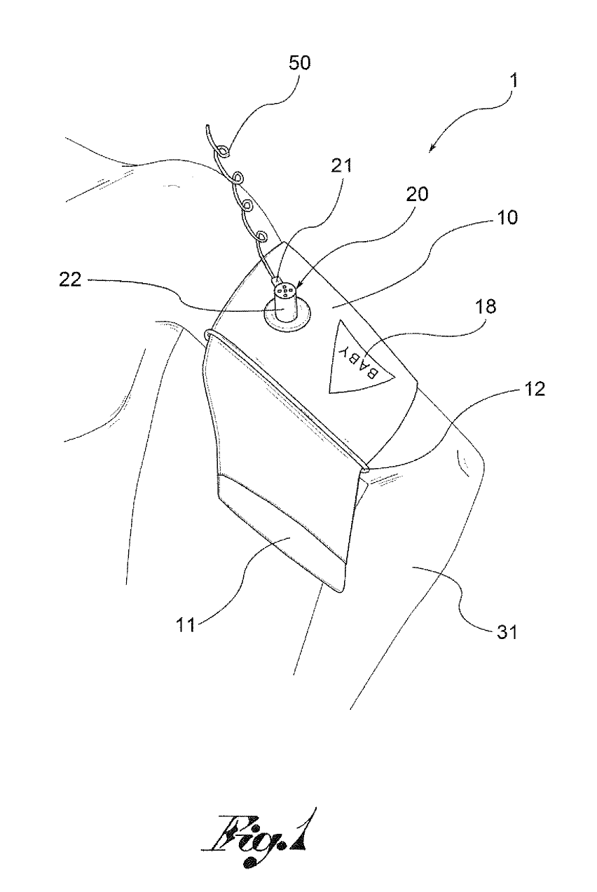

FIG. 1 shows an axonometric view of a safety device according to the invention;

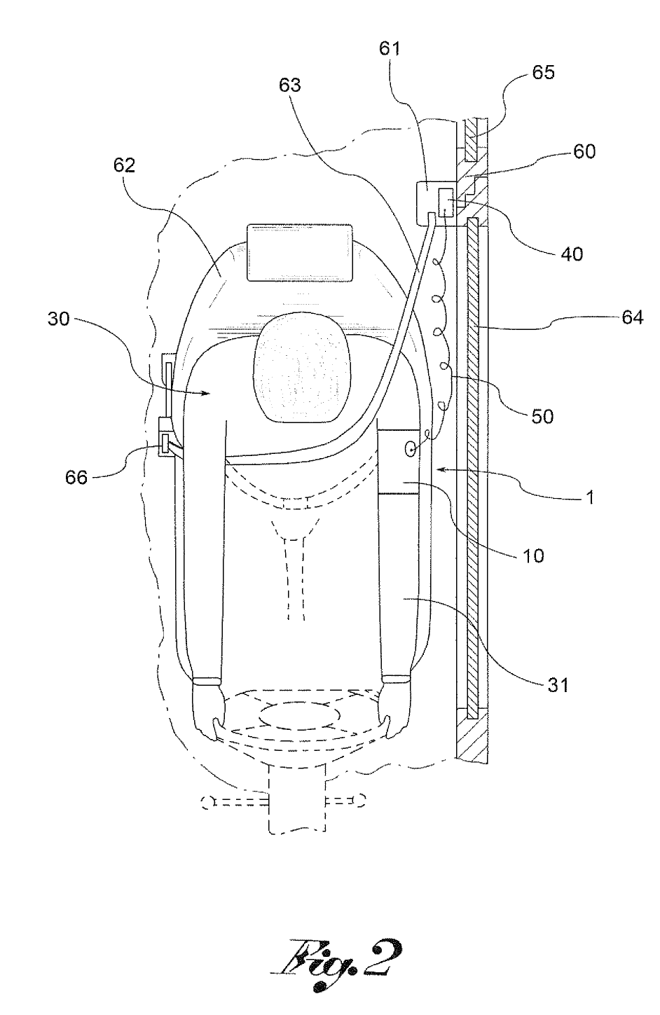

FIG. 2 shows the safety device according to the present invention, during the step of driving the vehicle;

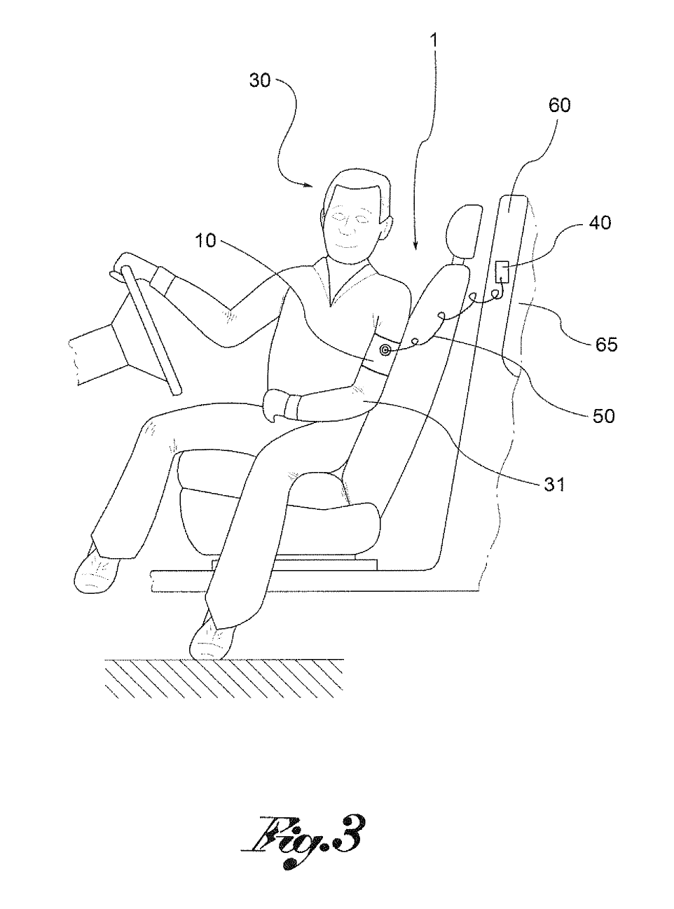

FIG. 3 shows the safety device according to the present invention, during the step of getting out of the vehicle;

FIGS. 4a and 4b respectively show a front and rear view of the safety device according to the present invention, in a first embodiment;

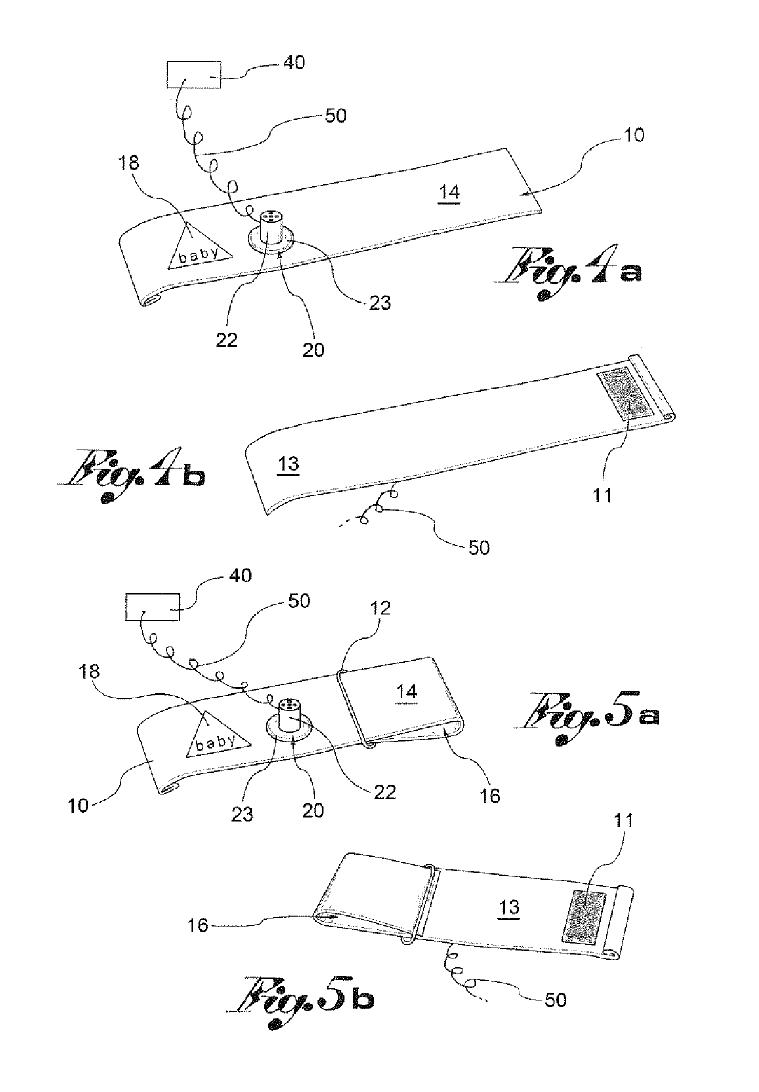

FIGS. 5a and 5b respectively show a front and rear view of the safety device according to the present invention, in a second embodiment;

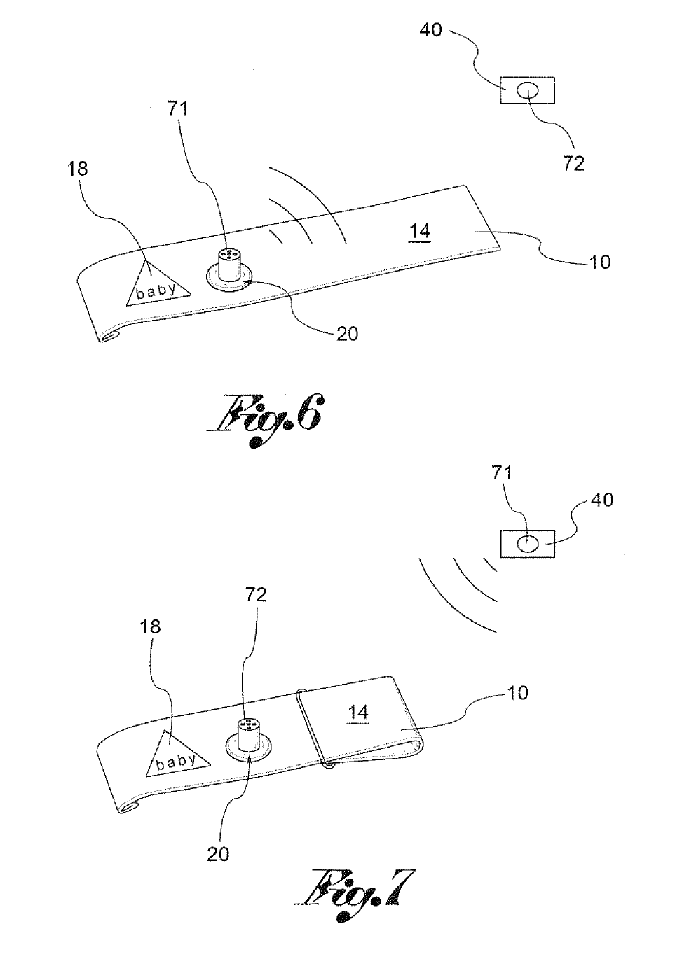

FIGS. 6 and 7 show a front view of the safety device according to the present invention, in an embodiment variant.

With reference to the appended drawings, reference numeral 1 globally denotes a safety device, in particular an alarm and signalling device of moving away from a child on board a vehicle.

The safety device 1 comprises a body 10 suitable to be worn by a user 30, for example on an arm 31. The body 10 comprises a front surface 14 and a rear surface 13.

Preferably, the body 10 is a strap, elastic, or in fabric, flexible enough to be wrapped around a part of the body of the user 30.

The strap 10 is provided with a fastening element 11, 12 making it possible to adjust and fasten the strap 10 around the arm 31 in a releasable manner.

In one example of an embodiment shown in FIGS. 4a, 4b and 6, the fastening element is a velcro band 11, attached to the rear surface 13 of the strap 10, suitable to permit the strap fastening of the strap 10.

In a further embodiment shown in FIGS. 5a, 5b and 7, the fastening element is a belt loop 12 making it possible to fold the strap 10 back on itself so as to form a loop 16 in which the arm 31 is inserted. The belt loop 12 thus permits the adjustment to measure of the diameter of the loop 16. Preferably, the strap also comprises a band 11 in Velcro, for the fastening in position of the strap 10.

In a further embodiment (not shown), the fastening element is a buckle making it possible to fold the strap 10 back on itself so as to form a loop 16 in which the arm 31 is inserted and at the same time to fix the strap 10 in position.

In yet a further embodiment (not shown), the strap is folded in a loop and fastened, for example by stitching, to form the loop 16 in which the arm 31 is inserted.

The strap 10 is also provided with at least one visual signalling element 18, provided on the front surface 14.

As shown in FIGS. 4a, 5a, 6 and 7, the visual signalling element 18 is an insert or band, made in reflective or fluorescent material, and/or having a different colour from the rest of the front surface 14, preferably a garish colour, and/or with letters, figures or pictures.

In one variant, the visual signalling element 18 is the front surface 14, made of reflective or fluorescent, material and/or in a garish colour and/or with letters, figures or pictures.

In the example in FIG. 1, the strap 10 is fitted with an insert signalling element 18, of a different colour to the rest of the front surface 14, and with the wording “BABY”. Furthermore, in the example in FIG. 1, the front surface 14 is also a signalling element 18, and is a garish colour, preferably red.

The safety device 1 comprises a base 40 suitable to be attached to the vehicle. The base 40 is for example fitted with an adhesive or Velcro or magnet or an elastic band for attachment to the chassis 60 of the vehicle or to an element of the interior furnishings of the vehicle, such as the box 61 housing the seat belt 63, or the seat belt 63 itself, or the buckle 66 of the seat belt 63, or the seat 62.

In an embodiment variant, shown in FIGS. 1 to 5, the safety device 1 comprises a connector 50 which joins, in a releasable manner, the body 10 to the base 40.

The connector 50 is for example a cord, a cable, an elastic band, a spring, a wire.

The safety device 1 comprises an alarm 20, suitable to emit an acoustic signal when it is activated, i.e. when the body 10 is disconnected from the base 40.

The alarm 20 is attached on one side to the body 10 (preferably on the front surface 14) or to the base 40, and on the other side is connected, in a releasable manner, to the connector 50. The alarm 20 is thus activated when the connector 50 is disconnected from the alarm 20.

In one embodiment, shown in FIG. 1, the alarm 20 is provided with a tongue 21 inserted in a releasable manner in a slot (not shown) provided on the body 22 of the alarm 20. As long as the tongue remains inserted in the slot 21 of the body 22, the alarm 20 stays off, and no acoustic signal is emitted. When the tongue is pulled out of the slot 21 of the body 22, the alarm 20 is activated and emits an acoustic signal. The tongue 21 being secured to the connector 50, by pulling the connector 50 with sufficient force the tongue 21 is removed from the slot in the body 22 and the alarm 20 is activated.

In a further embodiment, shown in FIGS. 4a and 5a, the alarm 20 has a body 22 connected in a releasable manner to a bottom 23, attached to the body 10 (or to the base 40). The body 22 is connected to the bottom 23, for example by means of a magnet or by interlocking. As long as the body 22 remains connected to the bottom 23, no acoustic signal is emitted. When the body 22 is separated from the bottom 23, the alarm 20 is activated and emits an acoustic signal. The body 22 being secured to the connector 50, by pulling the connector 50 with sufficient force the body 22 is separated from the bottom 23 and the alarm 20 is activated.

In an embodiment variant, shown in FIG. 1, the alarm 20 is attached to the body 10 and is releasably connected to the connector 50. The alarm 20 is activated when the body 10 is disconnected from the connector 50, which remains attached to the base 40.

In a further alternative embodiment, not shown, the alarm 20 is attached to the base 40 and is releasably connected to the connector 50. The alarm 20 is activated when the base 40 is disconnected from the connector 50, which remains attached to the body 10.

In use, the user 30, after placing the child in the vehicle, sits in the driving seat and puts on the safety device 1, in particular the strap 10, preferably on an arm 31.

As shown in FIG. 2, the choice between left or right arm depends on where the safety device 1 is attached, for example to the chassis 60 of the vehicle (for example on the central upright between the front 64 and rear windows 65), or on the box 61 housing the seat belt 63, or on the seat belt 63 itself, or on the buckle 66 of the seat belt, or on the seat 62.

The presence of the connector 50, of a certain length and flexibility, allows the user 30 to drive smoothly without the presence of the safety device 1, and in particular of the strap 10 around the arm 31, interfering with normal driving movements.

In a further embodiment, shown in FIGS. 6 and 7, the safety device 1 is free of the connector 50. In this embodiment variant, the body 10 is connected to the base 40 via a radio connection system.

This radio connection system comprises an emitter 71, suitable to emit a radio signal, and a receiver 72, suitable to receive the radio signal emitted by the radio emitter 71.

In an embodiment shown in FIG. 6, the emitter 71 is attached to the strap 10 (for example on the upper surface 14 or is integrated in the alarm 20) and the receiver 72 is attached to the base 40.

In an embodiment shown in FIG. 7, the emitter 71 is attached to the base 40 and the receiver 72 is attached to the body 10 (for example on the upper surface 14 or is integrated in the alarm 20).

The safety device 1 comprises an alarm 20, suitable to emit an acoustic signal when activated by the radio connection system for example when the receiver 72 no longer detects the signal emitted by the emitter 71 or when the receiver 72 detects that the emitter 71 has exceeded a predetermined maximum distance.

As shown in FIG. 3, at the time of getting out of the car, the presence of the strap 10 around the arm 31, fitted with a signalling element 18, indicates to the user 30 the moving away from the child in the vehicle. The user 30 then proceeds to remove the safety device 1 and then the strap 10 without any alarm being triggered, and takes the child out of the vehicle.

In the event in which the user 30 should forget about the safety device 1 and try to get out of the vehicle without removing the strap 10, the presence of the connector 50 (which substantially ties the user 30 to the vehicle), alerts the user 30 that he/she is moving away from the child on board. The user 30, feeling the tug of the connector 50 remembers, removes the safety device 1 without any alarm being triggered, and taking the child out of the vehicle.

In the case of the of the embodiment variant shown in FIGS. 1 to 5, if the user 30 gets out of the vehicle without removing the safety device 1, he pulls the connector 50 which detaches from the strap 10 or from the base 40 and triggers the alarm 20. The alarm 20 generates an acoustic alarm which warns the user 30 of moving away from the child in the vehicle. The user 30 remembers, removes the safety device 1, which continues to emit the acoustic alarm, and takes the child out of the vehicle. Once the connector 50 has been reconnected to the base 40 or to the strap 10, the alarm ceases to emit acoustic signals 20.

In the case of the embodiment variant shown in FIGS. 6 and 7, if the user 30 gets out of the vehicle without removing the safety device 1, the radio connection system (no longer detecting the signal emitted by the emitter 71 or by detecting that the predetermined maximum distance between the emitter 71 and the receiver 72 has been exceeded) triggers the alarm 20. The alarm′20 generates an acoustic alarm which warns the user 30 of moving away from the child in the vehicle. The user 30 remembers, removes the safety device 1, which continues to emit the acoustic alarm, and takes the child out of the vehicle. Once the base 40 is put back close to the strap 10, the alarm 20 ceases to emit acoustic signals.

If the user leaves the vehicle 30 without taking off the band 10 and a malfunction of the alarm 20 occurs which does not activate correctly (when the connector 50 is detached from the strap 10 or from the base 40 or when the radio connection system no longer detects the signal emitted by the emitter 71 or detects that the predetermined maximum distance between the emitter 71 and the receiver 72 has been exceeded), the presence of the strap 10 around the arm 31, with at least one signalling element 18 visually alerts the user 30, or a passer-by who sees the user 30 with the strap 10 around the arm 31, moving away from the child in the vehicle. The user 30 remembers, or is notified by the passer-by of his forgetfulness, and takes the child out of the vehicle.

The safety device 1 is thus fitted with an alarm device 20 and at least one visual signalling element 18 suitable t alert the user 30, at the moment of getting out of the vehicle, of moving from the child board.

Innovatively, the safety device according to the present invention is simple and effective at the same time.

Advantageously, the safety device according to the present invention is extremely reliable in that it, is provided with both an alarm device and at least one visual signalling element capable of signalling the moving away from child on board even in case of malfunction of the alarm device.

Advantageously, the safety device according to the present invention is economical and practical, since it need only be fitted by the user at the time of getting into the vehicle and may be installed on board without the need for substantial work on the vehicle itself.

Advantageously, the safety device according to the present invention allows the user to drive smoothly without interfering with normal driving activities.

It is clear that a person skilled in the art may make modifications to the device described above, all contained within the scope of protection as defined by the following claims.

1. Safety device (1), in particular an alarm and signalling device of a user moving away from a child on board a vehicle, comprising:
a body (10) suitable to be worn by the user on board the vehicle,
a base (40) suitable to be attached to the vehicle,
an alarm (20), attached to the body (10) or to the base (40), suitable for emitting an acoustic signal when the body (10) disconnects from the base (40), so as to signal the moving away from a child on board the vehicle.

2. Safety device (1) according to claim 1, wherein the body (10) is a strap, sufficiently flexible to be wrapped around a part of the user's body.

3. Safety device (1) according to claim 2, wherein the strap (10) is fitted with a fastening element (11, 12) which permits the strap (10) to be adjusted and fastened in a releasable manner.

4. Safety device (1) according to claim 2 or 3, wherein the fastening element is a velcro band (11) or a loop (12) permitting the folding back of the strap (10) on itself to form a noose (16), or a buckle, or the strap (10) is folded into a loop and fastened to form a noose (16).

5. Safety device (1) according to any of the previous claims, wherein the body (10) is provided with at least one visual signalling element (18).

6. Safety device (1) according to claim 5, wherein the signalling element (18) is an insert or band, made in reflective or fluorescent material, and/or having a different colour to the rest of the body (10), and/or of a bright colour, and/or with letters, figures or pictures.

7. Safety device (1) according to any of the previous claims, wherein the body (10) is connected in a releasable manner to the base (40) by means of a connector (50).

8. Safety device (1) according to claim 7, wherein the alarm (20) is connected to the connector (50) and is activated when the connector (50) is disconnected.

9. Safety device (1) according to claim 7 or 8, wherein the alarm (20) is connected to the connector (50) by means of a tongue (21) inserted in a releasable manner in a special split, or by means of a magnet or snap-engaged.

10. Safety device (1) according to claim 7 or 8 or 9, wherein the connector (50) is a cord, a cable, an elastic, a spring or a wire.

11. Safety device (1) according to any of the claims from 1 to 6, wherein the body (10) is connected to the base (40) by means of a radio connection system.

12. Safety device (1) according to claim 11, wherein the radio connection system comprises an emitter (71), suitable to emit a radio signal, and a receiver (72), suitable to receive the radio signal emitted by the emitter (71), and wherein either the emitter (71) or the receiver (72) is attached to the body (10) and the other is attached to the base (40).

13. Safety device (1) according to claim 12, wherein the alarm (20) is connected to the emitter (71) or to the M receiver (72), and is activated when the receiver (72) no longer detects the signal emitted by the emitter (71) or when the receiver (72) detects that the emitter (71) has exceeded a maximum predefined distance.

14. Safety device (1) according to any of the previous claims, wherein the base (40) is provided with an adhesive or velcro or a magnet or elastic band for attachment to the vehicle or to an internal furnishing element of the vehicle.
